(19) United States
(12) Patent Application Publication
(10) Pub. No.: US 2012/0233024 A1
(43) Pub. Date: Sep. 13, 2012

(54) SYSTEM AND METHOD FOR MOBILE PROXIMITY SEARCHING

(75) Inventor: Stephen Boyd, Murrieta, CA (US)

(73) Assignee: MOBUBBLE, INC., Murrieta, CA (US)

(21) Appl. No.: 13/210,235

(22) Filed: Aug. 15, 2011

Related U.S. Application Data
(60) Provisional application No. 61/451,555, filed on Mar. 10, 2011.
(60) Provisional application No. 61/488,674, filed on May 20, 2011.

(51) Int. Cl. G06Q 30/00; G01S 5/02

(52) U.S. Cl. 705/26.61; 342/463

(57) ABSTRACT

In accordance with aspects of the disclosure, a method, apparatus, and computer program product are provided for wireless communication. The method, apparatus, and computer program product may be configured to reference moving positional points within a defined proximity and search a parameter based on the moving positional points. The defined proximity may comprise a region of influence defined by a radial distance from each of the moving positional points.

### CROSS-REFERENCE TO RELATED APPLICATION(S)

This application claims priority to and the benefit of U.S. Provisional Application Ser. No. 61/451,555, entitled “System and Method for Mobile Proximity Searching,” filed on Mar. 10, 2011 and to U.S. Provisional Application Ser. No. 61/488,674, of the same title, filed on May 20, 2011, which both are expressly incorporated by reference herein in their entirety.

### BACKGROUND

1. Field

The present disclosure relates generally to communication systems, and more particularly, to proximity searching in wireless communication systems.

2. Background

In electronic commerce, a user typically searches market listing sites, selects services for purchase, and pays for services through electronic transfer of funds over a network, such as the Internet. However, to view local services offered for purchase, the user is often redirected to one or more other sites to view local service providers, which can be time-consuming and inefficient. Moreover, some of these local service providers may not have the ability to directly communicate with the user to negotiate purchases, which can be difficult and inconvenient for the user. As such, there exists a need to simplify the process of searching for services and searching for local service providers over a network.

### SUMMARY

In accordance with an aspect of the disclosure, an apparatus for wireless communication comprises a processing system configured to reference moving positional points within a defined proximity and search a parameter based on the moving positional points.

In accordance with an aspect of the disclosure, a method for wireless communication comprises referencing moving positional points within a defined proximity and searching a parameter based on the moving positional points.

In accordance with an aspect of the disclosure, an apparatus for wireless communication comprises means for referencing moving positional points within a defined proximity and means for searching a parameter based on the moving positional points.

In accordance with an aspect of the disclosure, a computer program product comprises a computer-readable medium comprising code executable by an apparatus to reference moving positional points within a defined proximity and search a parameter based on the moving positional points.

### BRIEF DESCRIPTION OF THE DRAWINGS

FIG. 1 is a diagram illustrating an embodiment of a wireless communication system, in accordance with aspects of the disclosure.

FIG. 2 is a diagram illustrating an implementation structure for referencing moving positional points, in accordance with aspects of the disclosure

FIG. 3 is a diagram illustrating a process flow for defining proximity search parameters within a defined proximity, in accordance with aspects of the disclosure.

FIG. 4 is a diagram illustrating an embodiment of trending analysis that may be performed in a region of influence, in accordance with aspects of the disclosure.

FIG. 5 is a diagram illustrating an embodiment of a service area along a path, in accordance with aspects of the disclosure.

FIG. 6 is a diagram illustrating an embodiment of listing opportunities within a region of influence, in accordance with aspects of the disclosure.

FIG. 7 is a diagram illustrating an embodiment of providing information related to coupon opportunities within a region of influence, in accordance with aspects of the disclosure.

FIGS. 8A-8P are drawings illustrating screenshots of various user interface applications, in accordance with aspects of the disclosure.

FIGS. 9A-9B are diagrams illustrating various embodiments of apparatuses suitable for implementing aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of communication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Those skilled in the art will recognize how best to implement the described functionality presented throughout this disclosure depending on the particular application and the overall design constraints imposed on the overall system.

Aspects of the disclosure provide for an apparatus for wireless communication comprising a processing system configured to reference moving positional points within a defined proximity and search a parameter based on the moving positional points. The defined proximity may comprise a region of influence defined by a radial distance from each of the moving positional points. The moving positional points may comprise positioning coordinates (e.g., GPS coordinates) of one or more wireless devices. The processing system may be configured to track moving positional points along a path and define a service area based on the tracked positional points along the path. The parameters may include at least one of services offered for sale and services wanted for purchase.

In an implementation, the processing system may be configured to reference moving positional points of a plurality of wireless devices within the defined proximity, track the moving positional points of each wireless device within the defined proximity, and search one or more parameters for each wireless device based on the moving positional points of each wireless device. The processing system may be configured to notify at least one of the wireless devices when at least one other wireless device is within the defined proximity based on the search parameters. The processing system may be configured to notify each of the wireless devices of each other wireless device that is within the defined proximity based on the search parameters. The processing system may be configured to notify at least one of the wireless devices of one or more opportunities provided by at least one other wireless device that is within the defined proximity based on the search parameters. The processing system may be further configured to analyze competition of the wireless devices that are within the defined proximity based on the search parameters and provide information to the wireless devices regarding the analyzed competition.

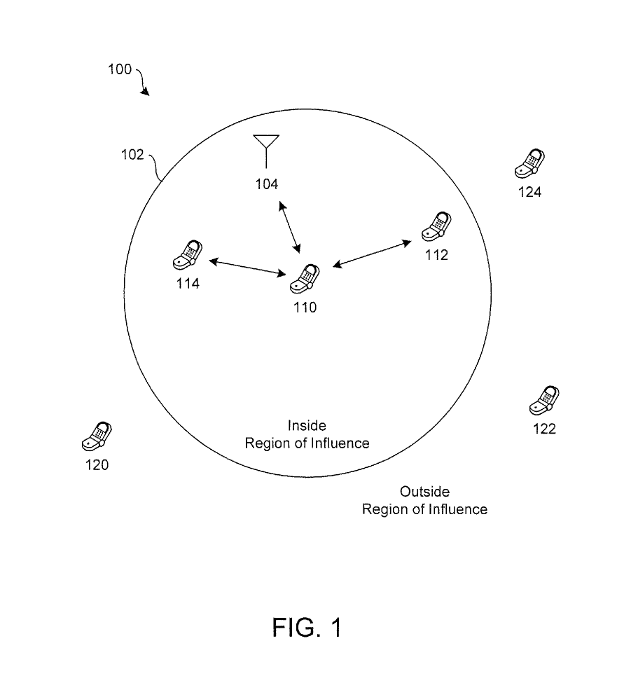

FIG. 1 is a diagram illustrating a wireless communication system 100 having a region of influence 102 (i.e., a bubble), in accordance with aspects of the disclosure.

As shown in FIG. 1, a wireless device 110 may offer services based on the region of influence 102, which may comprise, for example, a radius defined by a user of the wireless device 110. In an example, wireless devices 112, 114 and a base station 104 are inside the region of influence 102, and wireless devices 120, 122, 124 are outside the region of influence 102. It should be appreciated that, at any time, any one of the wireless devices 112, 114, 120, 122, 124 may cross between a boundary for the region of influence 102 from inside to outside or outside to inside. In various examples, the base station 104 may be positioned inside or outside the region of influence 102, and the base station 104 is configured to communicate with each of the wireless devices 110, 112, 114, 120, 122, 124 from inside or outside the region of influence 102.

In an implementation, searches may be based on moving positional points as wireless devices 110, 112, 114, 120, 122, 124 move across the boundary for the region of influence 102. The region of influence 102 may be referred to as a path, service area, and/or range of positional points (e.g., GPS coordinates) that reference the same wireless device, such as the wireless device 110.

In an implementation, each wireless device 110, 112, 114, 120, 122, 124 may be tracked with a type of positioning system, such as a global positioning system (GPS), to identify a location of each wireless device 110, 112, 114, 120, 122, 124 in relation to each other wireless device 110, 112, 114, 120, 122, 124. Each wireless device 110, 112, 114, 120, 122, 124 may be registered with the base station 104 to provide a tracking service. An application may be simultaneously run on each wireless device 110, 112, 114, 120, 122, 124 to provide multiple positional points. As such, in an example, the wireless device 110 may be aware of the position of each other wireless device 112, 114, 120, 122, 124, and the wireless device 110 may be aware of which wireless devices 112, 114, 120, 122, 124 are within the region of influence 102. In an example, the region of influence 102 may defined by the user of wireless device 110 as having a radius of a particular distance, such as for example, 25 miles. In various examples, the radius may vary to be any distance.

In an implementation, notifications are configured to alert users of updates, connections, etc. that occur within a user's region of influence (i.e., mobile bubble). When the wireless device 110 becomes aware or is notified that other wireless devices are within the region of influence 102, the wireless device 110 may receive information from, for example, the base station 104 regarding one or more services offered by the wireless devices 112, 114, if predetermined conditions are met. For example, if the user of the wireless device 110 is searching for a particular service, such as landscaping services, and the wireless device 114 identifies itself as a landscaping service contractor, then the wireless device 110 receives information related to the wireless device 114 when the wireless device 114 enters the region of influence 102. In another example, if the other wireless device 112 is not a landscape service contractor, then the wireless device 110 does not receive information related to the other wireless device 112 when the wireless device 112 enters the region of influence 102.

In still another example, the wireless device 110 may be updated periodically regarding known wireless devices, such as wireless devices 112, 114, that have entered the region of influence 102 and that have met one or more conditions defined by the user of the wireless device 110, such as a request for particular services. The periodic update may occur in a defined period of time, such as, for example, updates every 30 seconds. In an example, the base station 104 may comprise a server configured to process searches and continuously update the wireless device 110. The periodic updates may occur until the user finds someone to fulfill the defined condition set by the user of the wireless device 110, which may be referred to a persistent search, wherein the search is continuously searched until a match is found or until one or more desired services are found.

Each user of a wireless device 110, 112, 114, 120, 122, 124 may set a profile of services available and/or other parameters, such as interests, sports, social events, various associations, etc., defined by each user. Each wireless device 110, 112, 114, 120, 122, 124 may be monitored for position via UPS, and each user's location may be utilized to determine when the user enters the region of influence for the wireless device 110. Aspects of the disclosure provide means for searching and/or offering services and/or various other related associations via a wireless device, such as a mobile phone.

The wireless devices 110, 112, 114, 120, 122, 124 may be configured for thread messaging by way of texting back and forth in a conversation mode, such as a thread view. For example, when two users are within a particular GPS proximity, such as within the region of influence 102, then these users may connect if one of the users are searching for something the other user is offering or vice versa. As such, aspects of the disclosure seek to match a searching user with an offering user when the users are within a particular GPS proximity, such as within the region of influence 102. This may be referred to as being within the same bubble or defined radial distance. In various example, proximity searches, offers, and updates may occur in real time.

In an implementation, each of the wireless devices 110, 112, 114, 120, 122, 124 may comprise a processing system configured to operate as a persistence engine that match nodes (i.e., wireless devices) based on parameters set by each user. The processing system may be configured as a mobile proximity search engine that persistently references moving positional points (e.g., GPS coordinates) related to other wireless devices within the region of influence 102 defined by each user.

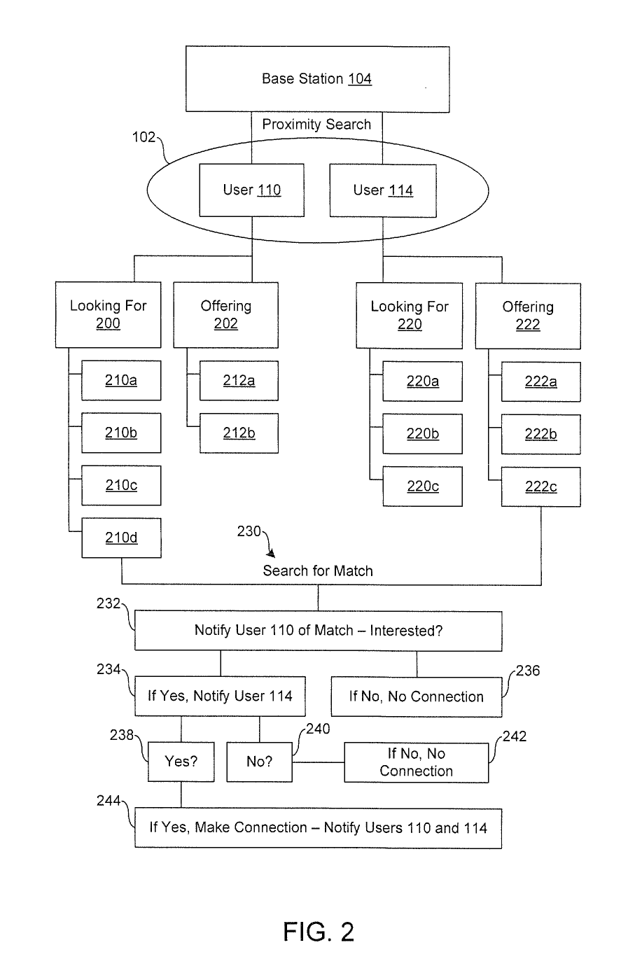

FIG. 2 is a diagram illustrating an implementation structure for referencing moving positional points related to each user's wireless device 110, 114 within a defined proximity (i.e., region of influence 102) and searching one or more parameters within the proximity based on the moving positional points related to users 110, 114, in accordance with aspects of the disclosure. As described in reference to FIG. 1, the wireless communication system 100 comprises the region of influence 102 (i.e., mobile bubble).

Referring to FIG. 2, the wireless device 110 may be looking for 200 one or more services 210a, 210b, 210c, 210d and/or offering 202 one or more services 212a, 212b within the region of influence 102, and the wireless device 114 may be looking for 220 one or more services 220a, 220b, 220c and/or offering 222 one or more services 222a, 222b, 222b within the region of influence 102. It should be appreciated that the users of the wireless devices 110, 114 may be respectively looking for 200, 220 and/or offering 202, 222 any number of services, without departing from the scope of the disclosure. As shown in FIG. 2, the wireless devices 110, 114 are inside the region of influence 102, and the wireless devices 110, 114 are in contact with the base station 104. In various implementations, the base station 104 may be positioned inside or outside the region of influence 102, and the base station 104 is configured to communicate with each of the wireless devices 110, 114 from inside or outside the region of influence 102.

In an implementation, each wireless device 110, 114 may conduct searches within the region of influence 102 based on moving positional points as the wireless devices 110, 114 move within the boundary for the region of influence 102. It should be appreciated that each user of wireless devices 110, 114 is configured to set their own parameters for their own region of influence. To simplify the discussion, the users of wireless device 110, 114 are within the same region of influence 102, as shown in FIG. 2.

In an implementation, when the wireless device 110 becomes aware or is notified that the other wireless device 114 is within the region of influence 102, the wireless device 110 may receive a notification from, for example, the base station 104 regarding one or more services offered by the wireless device 114, if predetermined conditions are met. For example, if the user of the wireless device 110 is searching for a particular service, such as service 210d, and the wireless device 114 identifies itself as a provider of service 222c, then a service match is searched and identified, and the wireless device 110 receives a notification including information related to the wireless device 114 when the wireless device 114 enters the region of influence 102.

In an implementation, if a search for match 230 occurs, then the wireless device 110 is notified of the match and if interested. If the user of the wireless device 110 is interested 234 in reviewing the match, then the user is sent a notification having information related to the matched service of the user of the wireless device 114. If the user of the wireless device 110 is not interested 236 in reviewing the match, then the user is not notified and no connection is made with the user of the wireless device 114. If, after review of the information of the matched service, the user of the wireless device 110 decides to make a connection 238 with the user of the wireless device 114, then a connection is made 244 with the user of the wireless device 114, and both users are notified of the connection. If, after review of the information of the matched service, the user of the wireless device 110 decides to not make a connection 240 with the user of the wireless device 114, then no connection is made 242 with the user of the wireless device 114.

The wireless devices 110, 114 may be updated periodically regarding known wireless devices that enter the region of influence 102 and have met one or more conditions defined by the users of the wireless devices 110, 114. The base station 104 may provide periodic updates to the wireless device 110, 114 in a defined period of time. The base station 104 may comprise a server configured to process searches for each wireless device 110, 114 and continuously update the wireless devices 110, 114. The periodic updates may be provided as a persistent search until each user of the wireless devices 110, 114 finds another user of a known wireless device to fulfill the defined condition set by each user of the wireless devices 110, 114. The base station uses the persistent search to continuously search for service matches in the region of influence 102 until a service match is found.

The base station 104 is configured to provide notifications in the form of thread messaging by way of texting in a conversation mode, such as a thread view. For example, when the users of wireless devices 110, 114 are within a particular GPS proximity, such as within the region of influence 102, then these users may connect if a service match is found to exist between the users. As such, the base station is configured to seek to match a searching user with an offering user when the users are within a particular GPS proximity, such as within the same region of influence 102 or mobile bubble. In various example, proximity searches, offers, and updates may occur in real time.

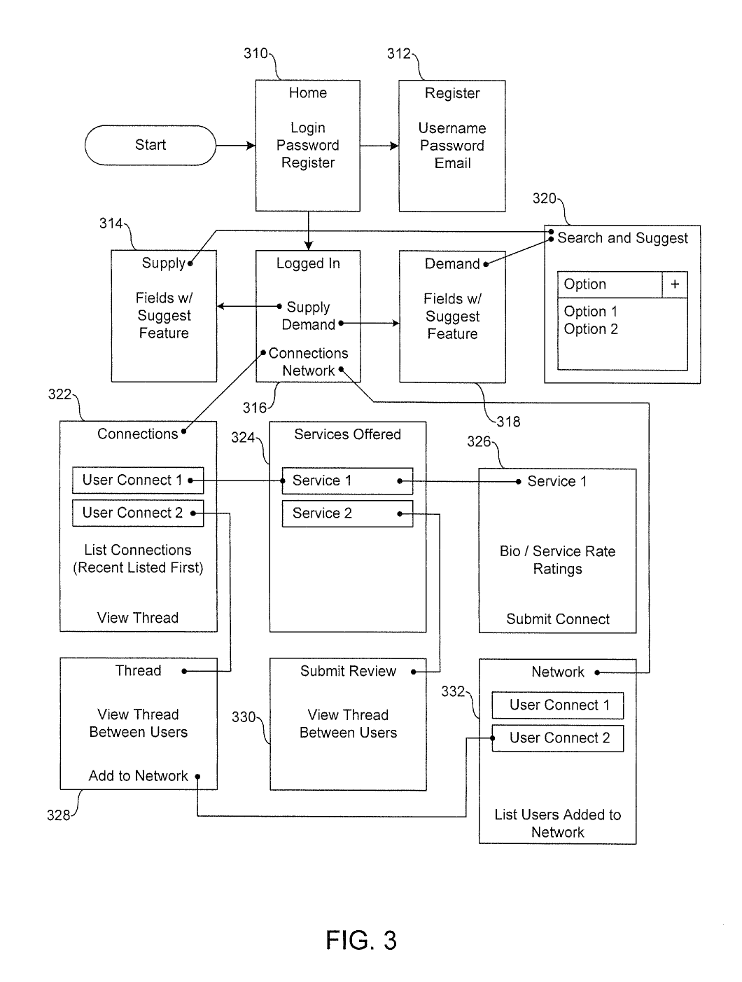

FIG. 3 is a diagram illustrating a process flow for defining proximity search parameters within a defined proximity (i.e., region of influence 102) and searching one or more parameters within the proximity, in accordance with aspects of the disclosure.

In an implementation, the process starts with accessing a home site or page 310 for the base station 104. The home site allows the user of a wireless device (e.g., wireless device 110) to login with a password and, if not a current member, register with the base station 104 as a member. If registering, the user of the wireless device 110 accesses a register or enrollment site or page 312 and provides a username, password, and/or email address for identification purposes. Once logged-in, the user of the wireless device 110 accesses a logged-in site or page 316 to provide proximity search parameters for supply (i.e., offerings) and demand (i.e., looking for). For supply, the user of the wireless device 110 accesses a supply site or page 314 to provide or enter supply fields for proximity searching, and for demand, the user of the wireless device 110 accesses a demand site or page 318 to provide or enter demand fields for proximity searching. Each of the supply and demand fields provides fields for search and suggest features in a page format 320 that provides selection of options for each supply and demand field. The page format 320 may be configured to allow entry of proximity search parameters and may be configured to provide entry suggestions based on option entries or descriptions of requested or offered services, which may include reference to previous searches conducted by the user.

In an implementation, the logged-in site or page 316 may provide the user of the wireless device 110 access to a connections site or page 322 to thereby access a list of connections with, for example, recent connections listed first. The connections site or page 322 may allow the user of the wireless device 110 to access a services offered site or page 324 to view services offered by connected users. For example, user connection 1 may offer service 1, and a description of the service 1 may be accessed to view information 326 related thereto including bio/service rate ratings. From the services offered site or page 324, the user of the wireless device 110 may submit a review 330 and view threads between users. The user of the wireless device 110 may submit for a connection. The connections site or page 322 may allow the user of the wireless device 110 to access a thread site or page 328 to view threads between users and add users to the network for connection. In an implementation, the logged-in site or page 316 may provide the user of the wireless device 110 access to a network site or page 332 that allows users to connect and add users to the network.

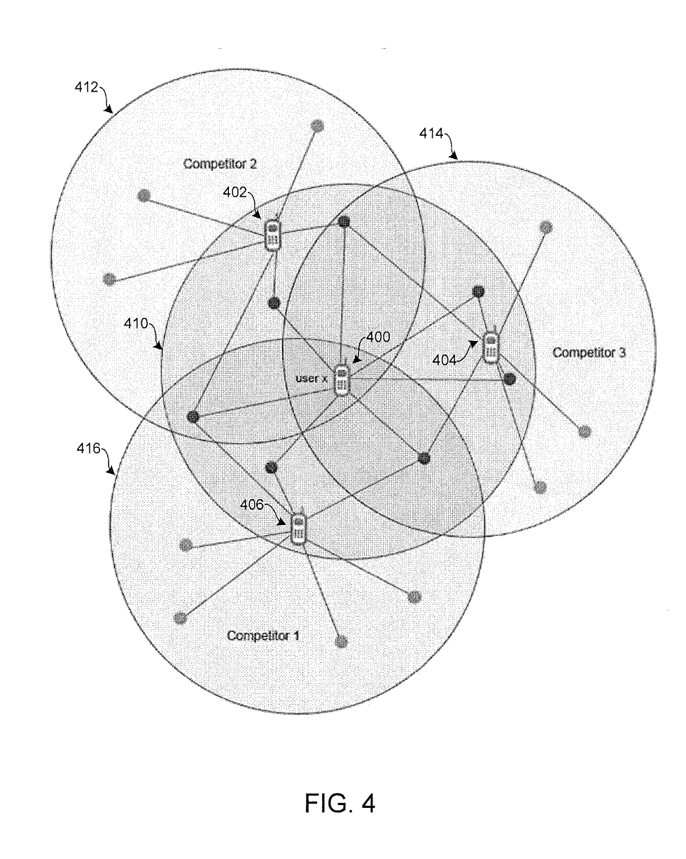

FIG. 4 is a diagram illustrating an embodiment of trending analysis that may be performed in a region of influence, in accordance with aspects of the disclosure.

As shown in FIG. 4, each wireless device 400, 402, 404, 406 comprises their own region of influence 410, 412, 414, 416. There are three layers of trending analysis: impressions, click-throughs, and connections. The diagram of FIG. 4 represents one layer. The trending analysis may be performed for each of the layers, and results of each trending analysis may be compared.

Users are considered competitors when they offer services with the same or similar keywords. Once a user offers the same or similar keyword as another user comes within their region of influence, which is a radius defined by the user, then those two users become virtual competitors. Once users are considered competition, then each user's information is included in the trending analysis. Competitors may be reset periodically, such as, in some examples, hourly, daily, weekly, monthly, etc.

For example, in the diagram of FIG. 4, the users of wireless devices 402, 404, 406 may be considered competitors. If all three competitors enter the region of influence 410 for user 400, then they are offering similar services that user 400 is searching for.

Trending analysis is as follows as depicted in a connection layer:

competitor 1 (406) has 7 connections,

competitor 2 (402) has 6 connections,

competitor 3 (404) has 7 connections, and

user x (400) has 7 connections.

What do connections mean? Is each connection point a connection with another user? Please provide further description . . .

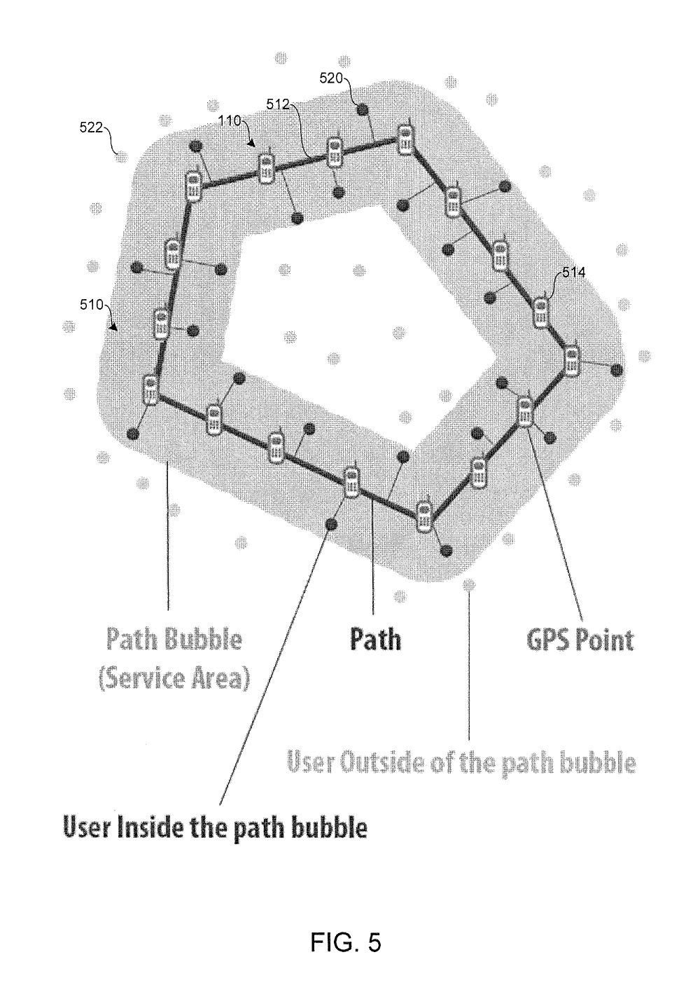

FIG. 5 is a diagram illustrating an embodiment of a service area 510 along a path 512, in accordance with aspects of the disclosure.

In an implementation, as a wireless device (e.g., wireless device 110) moves along the path 512, the wireless device 100 is configured to periodically provide GPS coordinates or points 514 along the path 512. As the wireless device 110 moves along the path 512, the region of influence for the wireless device 110 moves along the path 512 with the wireless device 110 to create the service area 510 or path bubble. While moving along the path 510, the user of the wireless device 110 may connect with users within or inside 522 the service area 510 or path bubble. Some users are outside 522 of the service area 510 or path bubble. Path tracking is configured to capture or connect with opportunities that exist on a predetermined route or path 510, even when the user moves away from the actual GPS coordinate or point 514. Path tracking allows the user of the wireless device 110 to expand their region of influence into the service area 510, which allows the user to interact on a network from multiple GPS points.

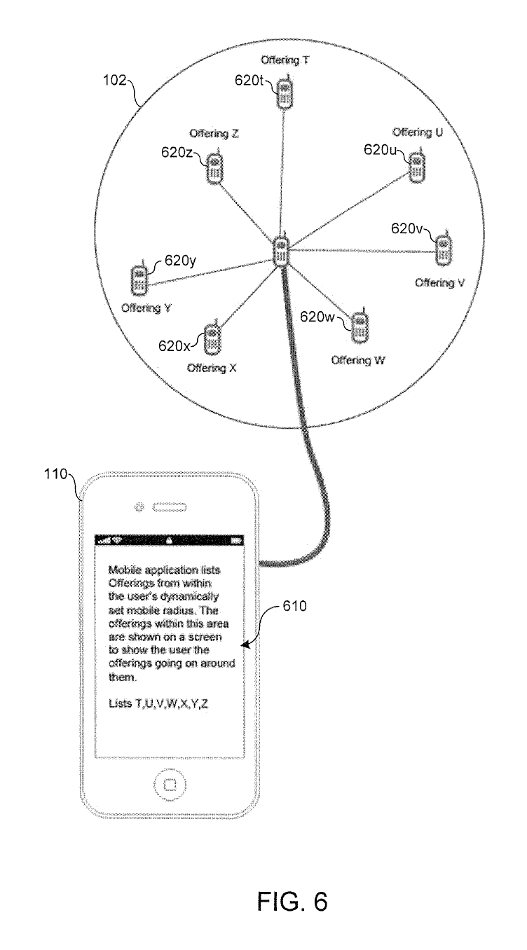

FIG. 6 is a diagram illustrating an embodiment of listing opportunities within a region of influence, in accordance with aspects of the disclosure.

In an implementation, the wireless device 110 is configured to list searches and offers currently available within a geographically defined radius (i.e., region of influence 102) to the user of the wireless device 110 via a display 610. For example, a plurality of wireless devices 620t, 620u, 620v, 620w, 620x, 620y, 620z may cross the boundary of the region of influence 102, and a connections may be made with one or more of the wireless devices 620t, 620u, 620v, 620w, 620x, 620y, 620z to provide information regarding one or more offerings T, U, V, W, X, Y, Z, respectively, to the wireless device 110 as a list of offerings T, U, V, W, X, Y, Z.

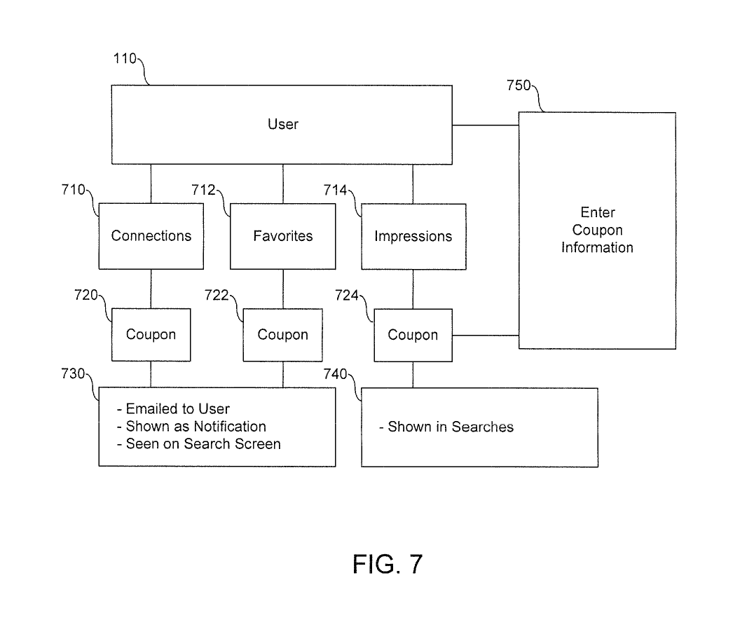

FIG. 7 is a diagram illustrating an embodiment of providing information related to coupon opportunities within a region of influence, in accordance with aspects of the disclosure.

In an implementation, the user of wireless device 110 is configured to provide coupon opportunities to proximity connections 710, favorites 712, and/or impressions 714 with respective coupon information 720, 722, 724. This couponing system gives users the ability to promote their service/micro-business to others on the network, wherein users may offer coupons to other users within their mobile proximity (i.e., region of influence). Coupon information may be entered or provided 750 by the user of the wireless device 110, and when users cross the boundary of the region of influence for the wireless device 110, then the base station 104 may send a notification having coupon information 730 to the user's wireless device via email, search screen, and/or various other notifications including a text message, a voice message, a page, etc. The notification may be shown in searches 740, for example, as search results when proximity searching for a match.

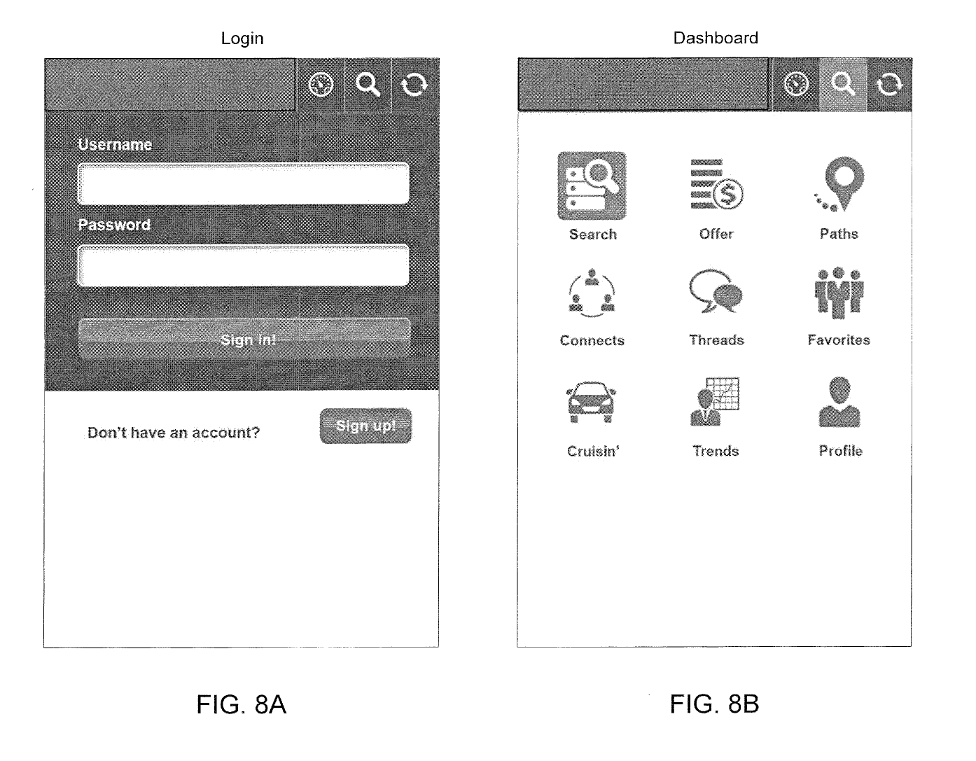

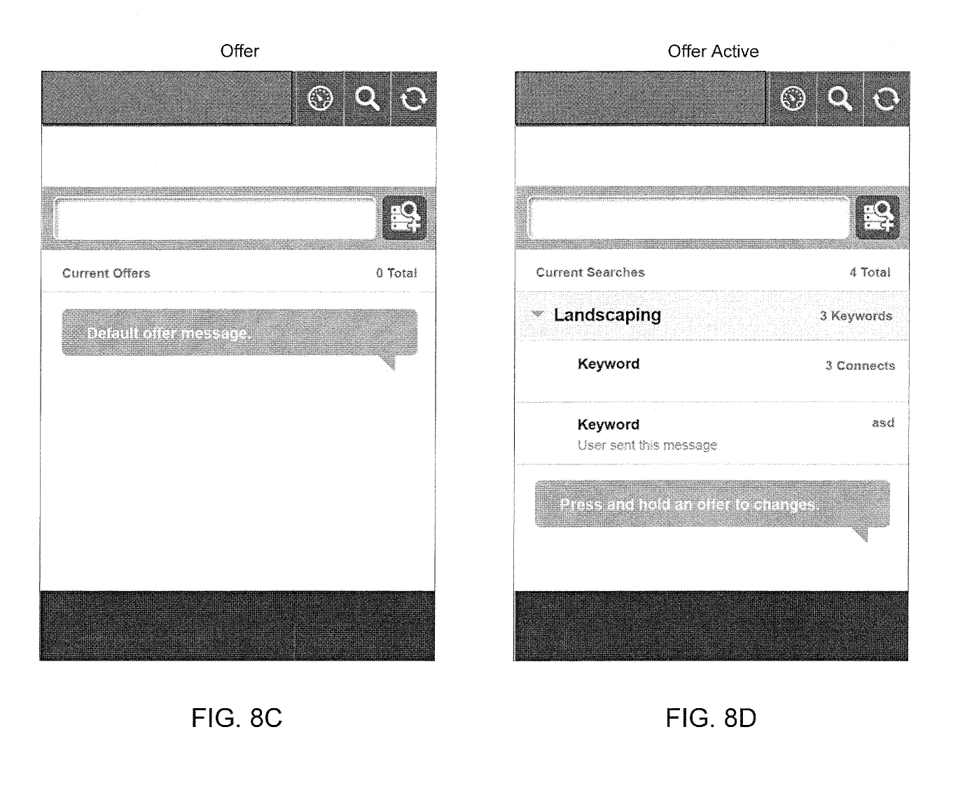

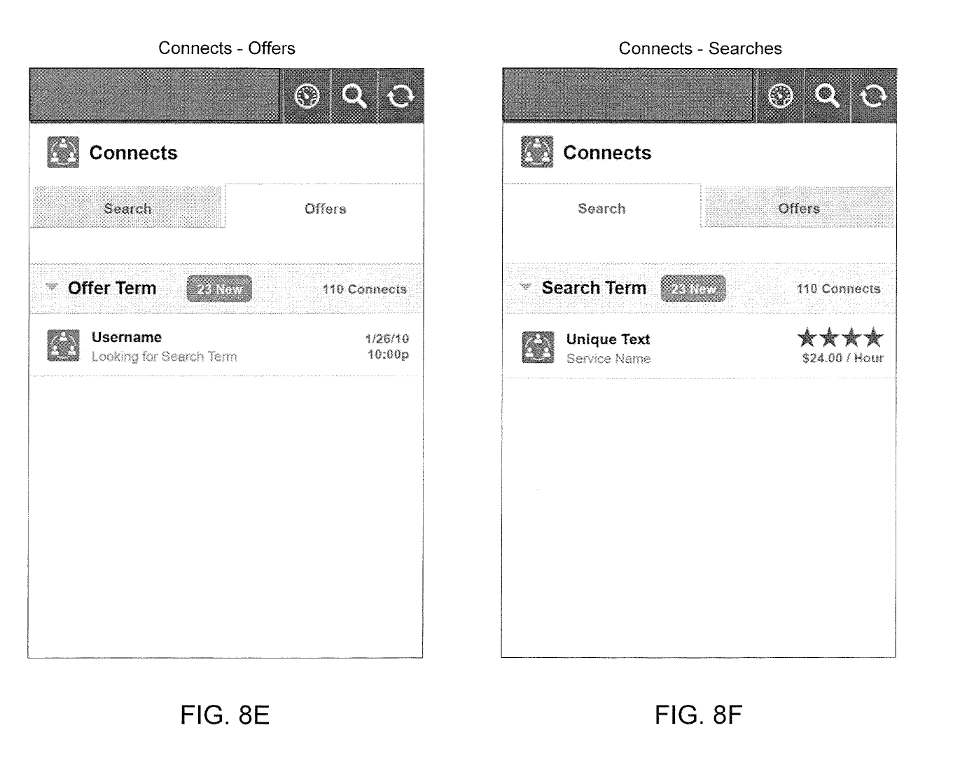

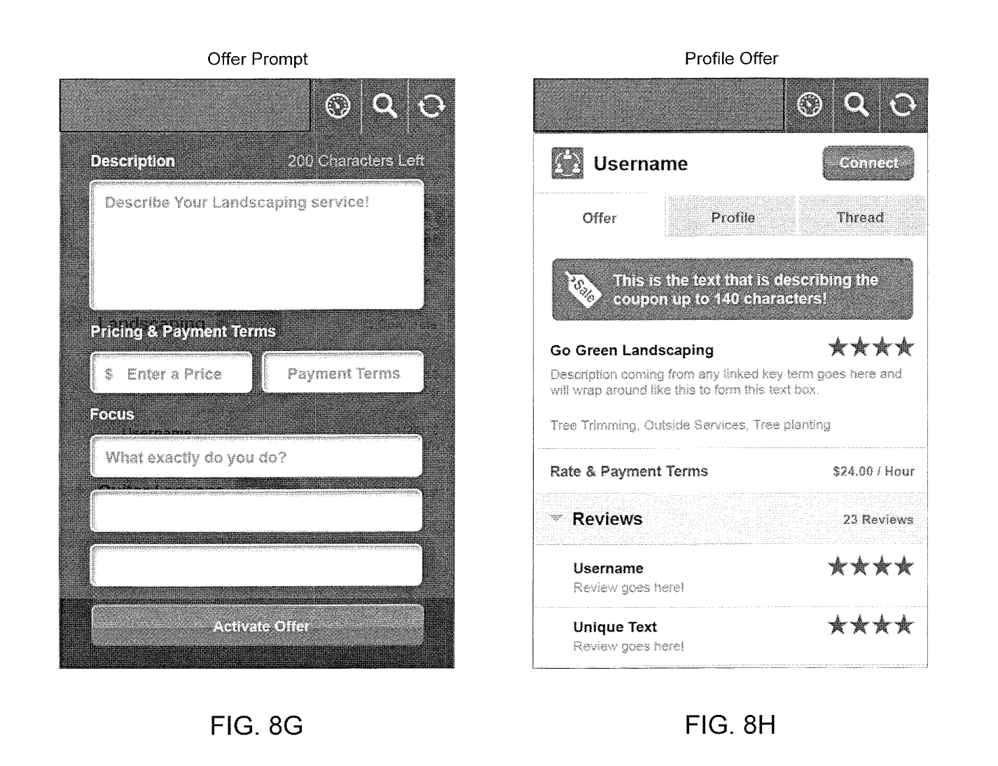

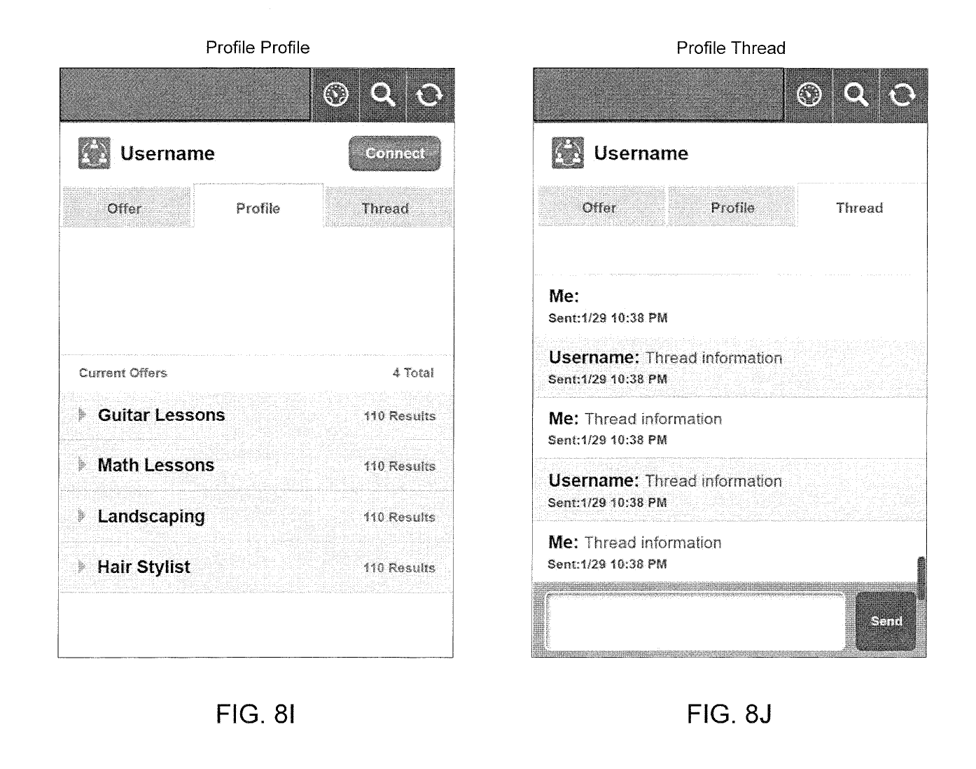

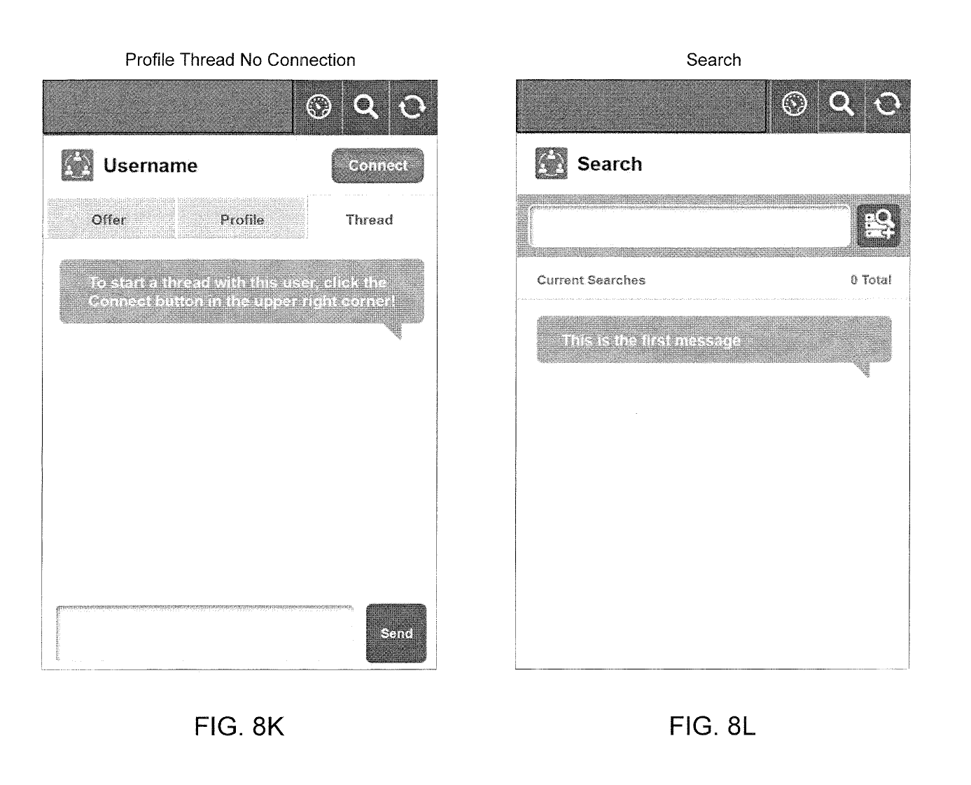

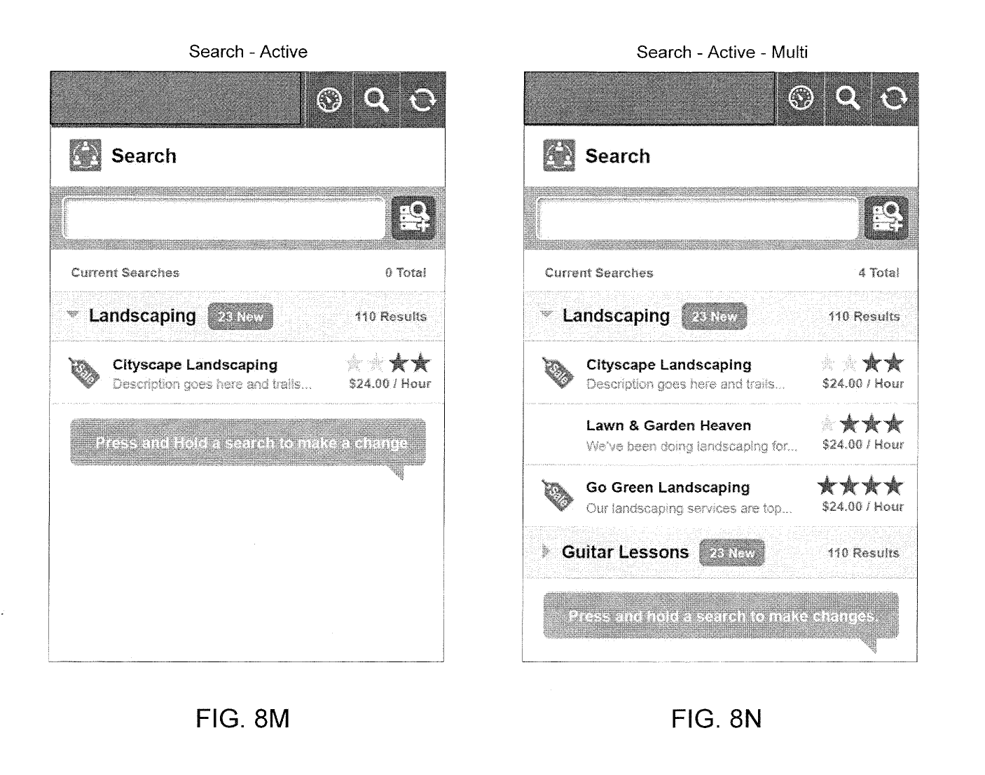

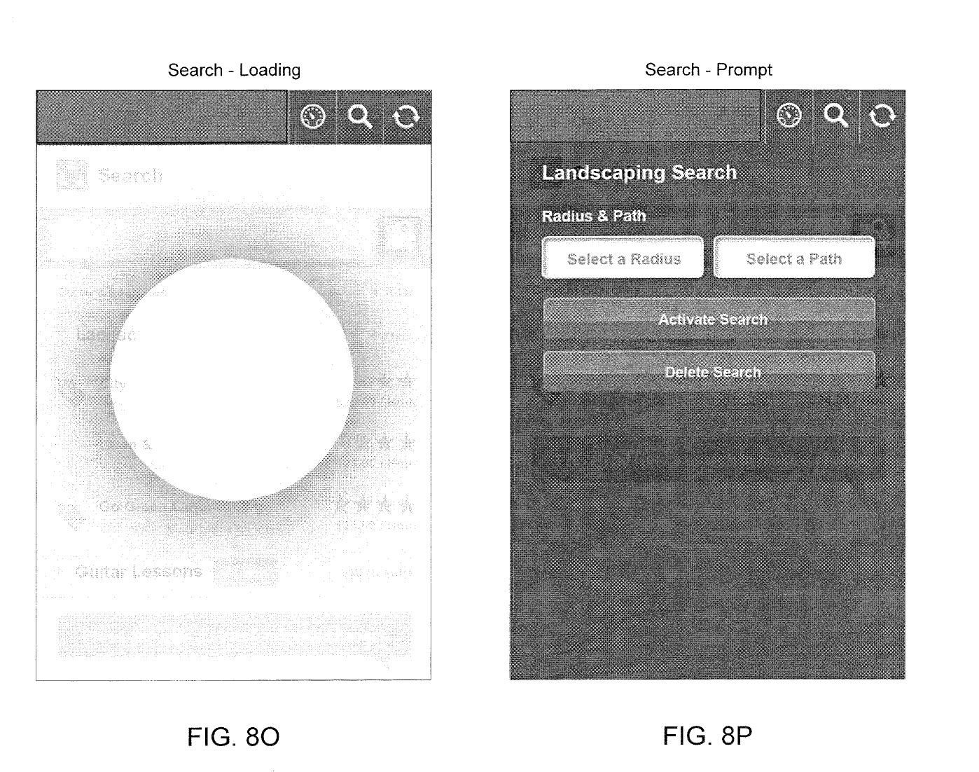

FIGS. 8A-8P are conceptual drawings illustrating screenshots of various user interface applications related to aspects of the disclosure.

FIG. 8A shows a login interface for a user, in accordance with an aspect of the disclosure.

FIG. 8B shows a dashboard interface for a user, in accordance with an aspect of the disclosure. As shown, the dashboard interface includes navigation links to various other user interface applications.

FIG. 8C shows a current offer interface for a user, in accordance with an aspect of the disclosure. As shown, the current offer interface allows the user to provide input related to offering a service to search.

FIG. 8D shows an active offer interface for a user, in accordance with an aspect of the disclosure. As shown, the active offer interface allows the user to provide input related to parameters for offering a service to search.

FIG. 8E shows a connect offer interface for a user, in accordance with an aspect of the disclosure. As shown, the connect offer interface allows the user to provide input related to offer terms for offering a service to search.

FIG. 8F shows a connect searches interface for a user, in accordance with an aspect of the disclosure. As shown, the connect searches interface allows the user to provide input related to search terms for searching for an offered service.

FIG. 8G shows an offer prompt interface for a user, in accordance with an aspect of the disclosure. As shown, the offer prompt interface allows the user to provide input related to defining parameters for offering a service to search.

FIG. 8H shows an offer profile interface for a user, in accordance with an aspect of the disclosure. As shown, the offer profile interface allows the user to provide input related to defining a profile for offering a service to search.

FIG. 8I shows a profile interface for a user, in accordance with an aspect of the disclosure. As shown, the profile interface allows the user to provide input related to defining a profile for offering a service to search.

FIG. 8J shows a profile thread interface for a user, in accordance with an aspect of the disclosure. As shown, the profile thread interface allows the user to provide input related to communicating with a searcher regarding a service offered by the user for search.

FIG. 8K shows a profile thread no connection interface for a user, in accordance with an aspect of the disclosure. As shown, the profile thread no connection interface allows the user to start a thread with a searcher.

FIG. 8L shows a search interface for a user, in accordance with an aspect of the disclosure. As shown, the search interface allows the user to provide input related to searching for a service offered by another user.

FIG. 8M shows an active search interface for a user, in accordance with an aspect of the disclosure. As shown, the active search interface allows the user to view and select information related to active searches.

FIG. 8N shows an active multi-search interface for a user, in accordance with an aspect of the disclosure. As shown, the active multi-search interface allows the user to view and select information related to multiple active searches.

FIG. 8O shows a search loading interface for a user, in accordance with an aspect of the disclosure.

FIG. 8P shows a search prompt interface for a user, in accordance with an aspect of the disclosure. As shown, the search prompt interface allows the user to provide input related to parameters for searching for a service offered by another user. In an example, the user may input a search radius and a search path as parameters for searching for a service offered by another user.

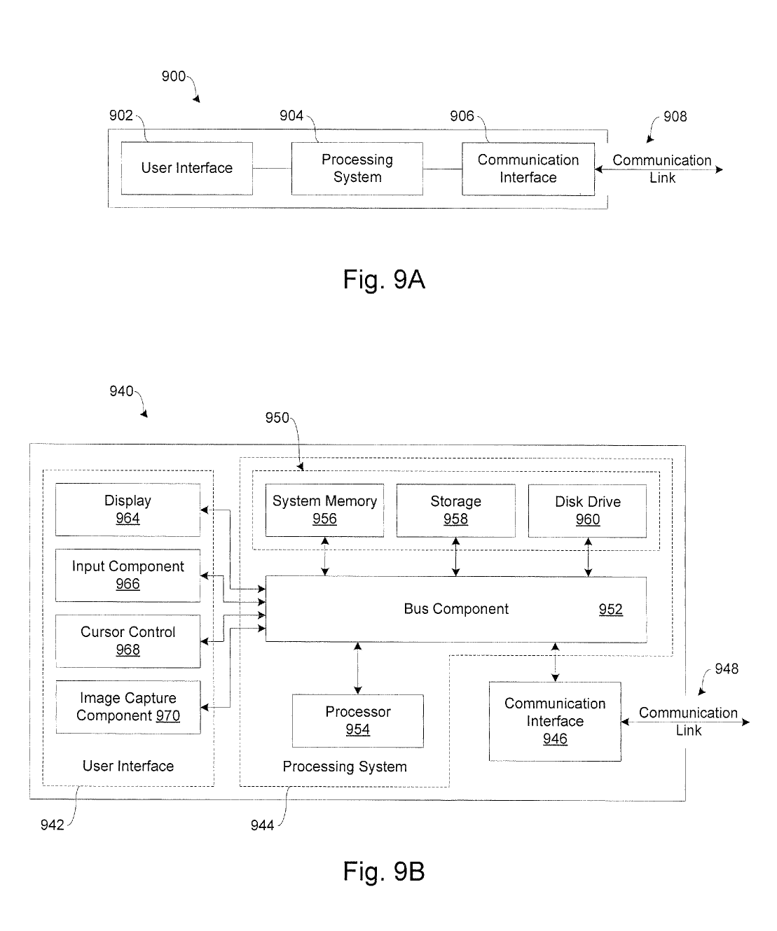

FIG. 9A is a block diagram of an apparatus 900 suitable for implementing various aspects of the disclosure. Referring to FIG. 1, the apparatus 900 may be utilized to implement the base station 104 (e.g., an access point, such as a server, configured for wireless communication in a wireless communication network) and/or each of the wireless devices 110, 112, 114, 120, 122, 124 (e.g., mobile communication devices, such as mobile phones, configured for wireless communication in a wireless communication network).

In accordance with an aspect of the disclosure, the apparatus 900 provides a means for interacting with the user comprising, for example, a user interface 902. The user interface 902 may include the utilization of one or more input components (e.g., keyboard), a cursor control component (e.g., touch screen), and image capture component (e.g., analog or digital camera). The user interface 902 may include the utilization of a display component (e.g., LCD).

In accordance with an aspect of the disclosure, the apparatus 900 comprises a processing system 904 that may be implemented with one or more processors. The one or more processors, or any of them, may be dedicated hardware or a hardware platform for executing software on a computer-readable medium. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In various implementations, the one or more processors may include, by way of example, any combination of microprocessors, microcontrollers, digital signal processors (DSPs), field programmable gate arrays (FPGAs), programmable logic devices (PLDs), state machines, gated logic, discrete hardware circuits, and other suitable processors configured to perform the various functionalities described throughout this disclosure.

In accordance with aspects of the disclosure, the functions described may be implemented in hardware, software, firmware, or any combination thereof. If implemented in software, the functions may be stored on or transmitted over as one or more instructions or code on a computer-readable medium. In various implementations, the computer-readable medium may include both computer storage media and communication media including any medium that facilitates transfer of a computer program from one place to another. A storage media may be any available media that can be accessed by a computer or processor. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Also, any connection is properly termed a computer-readable medium.

For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. In an implementation, computer readable medium may comprise non-transitory computer readable medium (e.g., tangible media). In another implementation, computer readable medium may comprise transitory computer readable medium (e.g., a signal). Combinations of the above should also be included within the scope of computer-readable media. The computer-readable medium may be embodied in a computer-program product. By way of example, a computer-program product may include a computer-readable medium in packaging materials.

In accordance with an aspect of the disclosure, the apparatus 900 comprises a communication interface 906 having one or more communication components that may be implemented to receive and/or transmit signals via one or more communication links 908. In various implementations, the communication interface 906 may comprise a short and/or long range communication component, such as a receiver, a transmitter, both a receiver and a transmitter, or a transceiver. As such, the communication interface 906 may utilize a wireless communication component and an antenna, such as a mobile cellular device, a wireless broadband device, a wireless satellite device, or various other types of wireless communication devices including radio frequency (RF), microwave frequency (MWF), and/or infrared frequency (IRF) devices adapted for wireless communication. The communication interface 906 may be configured to receive information from a user, and/or the communication interface 906 may be configured to transmit information to a user. In another example, the communication interface 906 may comprise a network interface component (e.g., modem or Ethernet card) to receive and transmit wired and/or wireless signals. The communication interface 906 may be adapted to interface and communicate with various types of networks, such as local area networks (LAN), wide area networks (WAN) including the Internet, public telephone switched networks (PTSN), and/or various other wired or wireless networks, including telecommunications, mobile, and cellular phone networks. The communication interface 906 may be adapted to interface with a DSL (e.g., Digital Subscriber Line) modem, a PSTN (Public Switched Telephone Network) modem, an Ethernet device, and/or various other types of wired and/or wireless network communication devices adapted for wired and/or wireless communication. The communication interface 906 may be configured as a network gateway, such as an Internet gateway.

FIG. 9B is a block diagram of an apparatus 940 suitable for implementing various aspects of the disclosure. The apparatus 940 may comprise a wired or wireless computing/processing/communication device (e.g., server, mobile phone, laptop, PC, PDA, game console, digital media player, television, etc.) capable of communicating with other wired or wireless devices in a network communication system. Referring to FIG. 1, the apparatus 940 may be utilized to implement the base station 104 (e.g., an access point, such as a server, configured for wireless communication in a wireless communication network) and/or each of the wireless devices 110, 112, 114, 120, 122, 124 (e.g., mobile communication devices, such as mobile phones, configured for wireless communication in a wireless communication network).

In accordance with various aspects of the disclosure, the apparatus 940 includes a processing system 944 having a processor 954 and a bus 952 and/or some other communication mechanism for communicating information, which interconnects subsystems and components, such as the processor 954 (e.g., processor, micro-controller, digital signal processor (DSP), etc.) and one or more computer readable media 950. The computer readable media 950 may include one or more of system memory 956 (e.g., RAM), static storage 958 (e.g., ROM), and disk drive storage 960 (e.g., magnetic or optical). The apparatus 940 includes a communication interface 946 (e.g., one or more wired or wireless communication components for short and/or long range communication and/or network communication), display 964 (e.g., LCD), input component 966 (e.g., keyboard), cursor control 968 (e.g., touch screen), and image capture component 970 (e.g., analog or digital camera). The disk drive 960 may comprise a database having one or more disk drives. It should be appreciated that any one of the memory components 956, 958, 960 may comprise a computer readable medium and be integrated as part of the processing component 954 to store computer readable instructions or code related thereto for performing various aspects of the disclosure. The communication interface 946 may utilize a wireless communication component and an antenna to communicate over one or more communication links 948.

In accordance with aspects of the disclosure, the apparatus 940 performs specific operations by the processor 954 causing execution of one or more sequences of one or more instructions contained in the computer readable media 950, such as the system memory 956. Such instructions may be read into the system memory 956 from another computer readable medium, such as the static storage 958 and/or the disk drive 960. In an implementation, hard-wired circuitry may be used in place of or in combination with software instructions to implement the disclosure.

Logic may be encoded in the computer readable medium 950, which may refer to any medium that participates in providing instructions to the processor 954 for execution. Such a medium may take many forms, including but not limited to, non-volatile media and volatile media. In various implementations, non-volatile media includes optical or magnetic disks, such as the disk drive 960, and volatile media includes dynamic memory, such as the system memory 956. In one aspect, data and information related to execution instructions may be transmitted to the apparatus 940 via transmission media, such as in the form of acoustic or light waves, including those generated during radio wave, micro wave, and infrared data communications. In various implementations, transmission media may include coaxial cables, copper wire, and fiber optics, including wires that comprise the bus 952.

Some common forms of computer readable media 950 includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various aspects of the disclosure, execution of instruction sequences to practice the disclosure may be performed by the apparatus 940. In various other aspects of the disclosure, a plurality of apparatuses 940 coupled by the one or more communication links 948, such as a short range wired or wireless communication medium, and/or network based communication including LAN, WLAN, PTSN, and/or various other wired or wireless communication networks, including telecommunications, mobile, and cellular phone networks) may perform instruction sequences to practice the disclosure in coordination with one another.

The apparatus 940 may transmit and receive messages, data, information and instructions, including one or more programs (i.e., application code) through the one or more communication links 948 and the communication interface 946. Received program code may be executed by the processor 954 as received and/or stored in the disk drive 960 or some other non-volatile memory or storage component for execution.

Referring to FIG. 9A, in one configuration, the apparatus 900 for wireless communication includes means for referencing moving positional points within a defined proximity and means for searching a parameter based on the moving positional points. The apparatus 900 may include additional modules that perform each of the steps in the aforementioned flow charts. As such, each step in the aforementioned flow charts may be performed by a module and the apparatus 900 may include one or more of those modules configured to perform various aspects of the disclosure. In an implementation, the aforementioned means comprises the processing system 904 configured to perform the functions recited by the aforementioned means.

Referring to FIG. 9B, in one configuration, the apparatus 940 for wireless communication includes means for referencing moving positional points within a defined proximity and means for searching a parameter based on the moving positional points. The apparatus 940 may include additional modules that perform each of the steps in the aforementioned flow charts. As such, each step in the aforementioned flow charts may be performed by a module and the apparatus 940 may include one or more of those modules configured to perform various aspects of the disclosure. In an implementation, the aforementioned means comprises the processing system 944 configured to perform the functions recited by the aforementioned means.

Where applicable, various aspects provided by the disclosure may be implemented using hardware, software, or combinations of hardware and software. Also, where applicable, the various hardware components and/or software components set forth herein may be combined into composite components comprising software, hardware, and/or both without departing from aspects of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be appreciated that like reference numerals are used to identify like elements illustrated in one or more of the figures, wherein showings therein are for purposes of illustrating aspects of the disclosure and not for purposes of limiting the same.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims.

Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus for wireless communication, comprising:
a processing system configured to reference moving positional points within a defined proximity, and search a parameter based on the moving positional points.

2. The apparatus of claim 1, wherein the defined proximity comprises a region of influence defined by a radial distance from each of the moving positional points.

3. The apparatus of claim 1, wherein the moving positional points comprise positioning coordinates of one or more wireless devices.

4. The apparatus of claim 1, wherein the processing system is further configured to track moving positional points along a path and define a service area based on the tracked positional points along the path.

5. The apparatus of claim 1, wherein the parameters include at least one of services offered for sale and services wanted for purchase.

6. The apparatus of claim 1, wherein the processing system is further configured to:
reference moving positional points of a plurality of wireless devices within the defined proximity;
track the moving positional points of each wireless device within the defined proximity; and
search one or more parameters for each wireless device based on the moving positional points of each wireless device.

7. The apparatus of claim 6, wherein the processing system is further configured to notify at least one of the wireless devices when at least one other wireless device is within the defined proximity based on the search parameters.

8. The apparatus of claim 6, wherein the processing system is further configured to notify each of the wireless devices of each other wireless device that is within the defined proximity based on the search parameters.

9. The apparatus of claim 6, wherein the processing system is further configured to notify at least one of the wireless devices of one or more opportunities provided by at least one other wireless device that is within the defined proximity based on the search parameters.

10. The apparatus of claim 6, wherein the processing system is further configured to analyze competition of the wireless devices that are within the defined proximity based on the search parameters and provide information to the wireless devices regarding the analyzed competition.

11. A method for wireless communication, comprising:
referencing moving positional points within a defined proximity, and
searching a parameter based on the moving positional points.

12. The method of claim 11, wherein the defined proximity comprises a region of influence defined by a radial distance from each of the moving positional points.

13. The method of claim 11, wherein the moving positional points comprise positioning coordinates of one or more wireless devices.

14. The method of claim 11, wherein the method further comprises tracking moving positional points along a path and defining a service area based on the tracked positional points along the path.

15. The method of claim 11, wherein the parameters include at least one of services offered for sale and services wanted for purchase.

16. The method of claim 11, wherein the method further comprises:
referencing moving positional points of a plurality of wireless devices within the defined proximity;
tracking the moving positional points of each wireless device within the defined proximity; and
searching one or more parameters for each wireless device based on the moving positional points of each wireless device.

17. The method of claim 16, wherein the method further comprises notifying at least one of the wireless devices when at least one other wireless device is within the defined proximity based on the search parameters.

18. The method of claim 16, wherein the method further comprises notifying each of the wireless devices of each other wireless device that is within the defined proximity based on the search parameters.

19. The method of claim 16, wherein the method further comprises notifying at least one of the wireless devices of one or more opportunities provided by at least one other wireless device that is within the defined proximity based on the search parameters.

20. The method of claim 16, wherein the method further comprises analyzing competition of the wireless devices that are within the defined proximity based on the search parameters and providing information to the wireless devices regarding the analyzed competition.

21. An apparatus for wireless communication, comprising:
means for referencing moving positional points within a defined proximity, and
means for searching a parameter based on the moving positional points.

22. The apparatus of claim 21, wherein the defined proximity comprises a region of influence defined by a radial distance from each of the moving positional points.

23. The apparatus of claim 21, wherein the moving positional points comprise positioning coordinates of one or more wireless devices.

24. The apparatus of claim 21, wherein the apparatus further comprises means for tracking moving positional points along a path and means for defining a service area based on the tracked positional points along the path.

25. The apparatus of claim 21, wherein the parameters include at least one of services offered for sale and services wanted for purchase.

26. The apparatus of claim 21, wherein the apparatus further comprises:
means for referencing moving positional points of a plurality of wireless devices within the defined proximity;
means for tracking the moving positional points of each wireless device within the defined proximity; and
means for searching one or more parameters for each wireless device based on the moving positional points of each wireless device.

27. The apparatus of claim 26, wherein the apparatus further comprises means for notifying at least one of the wireless devices when at least one other wireless device is within the defined proximity based on the search parameters.

28. The apparatus of claim 26, wherein the apparatus further comprises means for notifying each of the wireless devices of each other wireless device that is within the defined proximity based on the search parameters.

29. The apparatus of claim 26, wherein the apparatus further comprises means for notifying at least one of the wireless devices of one or more opportunities provided by at least one other wireless device that is within the defined proximity based on the search parameters.

30. The apparatus of claim 26, wherein the apparatus further comprises means for analyzing competition of the wireless devices that are within the defined proximity based on the search parameters and means for providing information to the wireless devices regarding the analyzed competition.

31. A computer program product, comprising:
a computer-readable medium comprising code executable by an apparatus to:
reference moving positional points within a defined proximity, and
search a parameter based on the moving positional points.

32. The computer program product of claim 31, wherein the defined proximity comprises a region of influence defined by a radial distance from each of the moving positional points.

33. The computer program product of claim 31, wherein the moving positional points comprise positioning coordinates of one or more wireless devices.

34. The computer program product of claim 31, wherein the computer-readable medium further comprises code executable by the apparatus to track moving positional points along a path and define a service area based on the tracked positional points along the path.

35. The computer program product of claim 31, wherein the parameters include at least one of services offered for sale and services wanted for purchase.

36. The computer program product of claim 31, wherein the computer-readable medium further comprises code executable by the apparatus to:
reference moving positional points of a plurality of wireless devices within the defined proximity;
track the moving positional points of each wireless device within the defined proximity; and
search one or more parameters for each wireless device based on the moving positional points of each wireless device.

37. The computer program product of claim 36, wherein the computer-readable medium further comprises code executable by the apparatus to notify at least one of the wireless devices when at least one other wireless device is within the defined proximity based on the search parameters.

38. The computer program product of claim 36, wherein the computer-readable medium further comprises code executable by the apparatus to notify each of the wireless devices of each other wireless device that is within the defined proximity based on the search parameters.

39. The computer program product of claim 36, wherein the computer-readable medium further comprises code executable by the apparatus to notify at least one of the wireless devices of one or more opportunities provided by at least one other wireless device that is within the defined proximity based on the search parameters.

40. The computer program product of claim 36, wherein the computer-readable medium further comprises code executable by the apparatus to analyze competition of the wireless devices that are within the defined proximity based on the search parameters and provide information to the wireless devices regarding the analyzed competition.
